(19) United States
(12) Patent Application Publication
(10) Pub. No.: US 2015/0060218 A1
(43) Pub. Date: Mar. 5, 2015

(54) Brake disc assembly

(71) Applicants: Ming-Hsin Liu, Changhua (TW); Chih-Sen Huang, Changhua (TW)

(72) Inventors: Ming-Hsin Liu, Changhua (TW); Chih-Sen Huang, Changhua (TW)

(21) Appl. No.: 14/537,933

(22) Filed: Nov. 11, 2014

(51) Int. Cl. F16D 65/12

(52) U.S. Cl. CPC F16D 65/12; F16D 2065/132
USPC 188/218 XL

(57) ABSTRACT

A brake disc assembly is provided with a ring including holes and protrusions equally spaced along an inner edge, each protrusion having an aperture distal the holes; a central part includes through holes equally spaced along a periphery, a central hole, and spaced hole members surrounding the central hole; externally threaded bolts; and internally threaded nuts. The through holes and the protrusions are in register. The externally threaded bolts are driven through the apertures and the through holes into the internally threaded nuts to fasten the ring and the central part together.

### BACKGROUND OF THE INVENTION

1. Field of the Invention

The invention relates to brake discs and more particularly to a brake disc assembly including a ring and a central part releasably secured to the ring, the central part having a low thermal conductivity so as to reduce heat transferred to the bearing in the hub.

2. Description of Related Art

A conventional brake disc A shown in FIG. 1 is a unit and includes a plurality of holes (two different sizes are shown) A1 and a central hole A2 surrounded by the hole A1. The brake disc A is formed of cast iron. Brake pads are actuated to clamp both side surfaces of the brake disc A when braking. Thus, high heat is generated and it can quickly transfer to a hub (not shown) secured to the central hole A2. Further, the heat may transfer to balls of a bearing (not shown). The bearing may be damaged after a short period of time of use. Thus, the need for improvement still exists.

### SUMMARY OF THE INVENTION

It is therefore one object of the invention to provide a brake disc assembly comprising a ring including a plurality of holes and a plurality of protrusions equally spaced along an inner edge, each protrusion having an aperture distal the holes; a central part includes a plurality of through holes equally spaced along a periphery, a central hole, and a plurality of spaced hole members surrounding the central hole; a plurality of externally threaded bolts; and a plurality of internally threaded nuts; wherein the through holes and the protrusions are in register; and wherein the externally threaded bolts are driven through the apertures and the through holes into the internally threaded nuts to fasten the ring and the central part together.

The above and other objects, features and advantages of the invention will become apparent from the following detailed description taken with the accompanying drawings.

### BRIEF DESCRIPTION OF THE DRAWINGS

FIG. 1 is a perspective view of a conventional brake disc;

FIG. 2 is an exploded view of a brake disc assembly according to a first preferred embodiment of the invention;

FIG. 3 is an exploded view showing the ring and the ring to be fastened by a fastening member;

FIG. 4 is a perspective view of the bolt shown in FIG. 3;

FIG. 5 is a perspective view of the assembled brake disc assembly shown in FIG. 2;

FIG. 6 is a sectional view showing the fastening member and adjacent portions of the ring and central part of FIG. 5;

FIG. 7 is a perspective view of a brake disc assembly incorporating a second configuration of the ring;

FIG. 8 is a view similar to FIG. 3 showing a second configuration of the fastening member and adjacent portions of the ring and central part;

FIG. 9 is a sectional view showing the fastening member and adjacent portions of the ring and central part of FIG. 8;

FIG. 10 is a view similar to FIG. 3 showing a three configuration of the fastening member and adjacent portions of the ring and central part;

FIG. 10A is a perspective view of the first fastening element of the fastening member;

FIG. 11 is a sectional view showing the fastening member and adjacent portions of the ring and central part of FIG. 10;

FIG. 12 is a perspective view of the brake disc assembly incorporating the fastening members shown in FIG. 10;

FIG. 13 an exploded view of a brake disc assembly according to a second preferred embodiment of the invention;

FIG. 14 is an exploded view showing the ring and the ring to be fastened by the fastening member of FIG. 13;

FIG. 15 is a perspective view of the assembled brake disc assembly shown in FIG. 13; and

FIG. 16 is a sectional view showing the fastening member and adjacent portions of the ring and central part of FIG. 15.

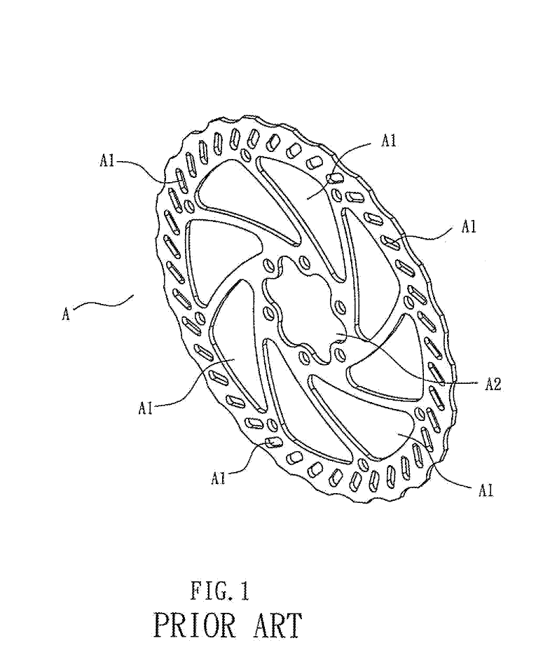

### DETAILED DESCRIPTION OF THE INVENTION

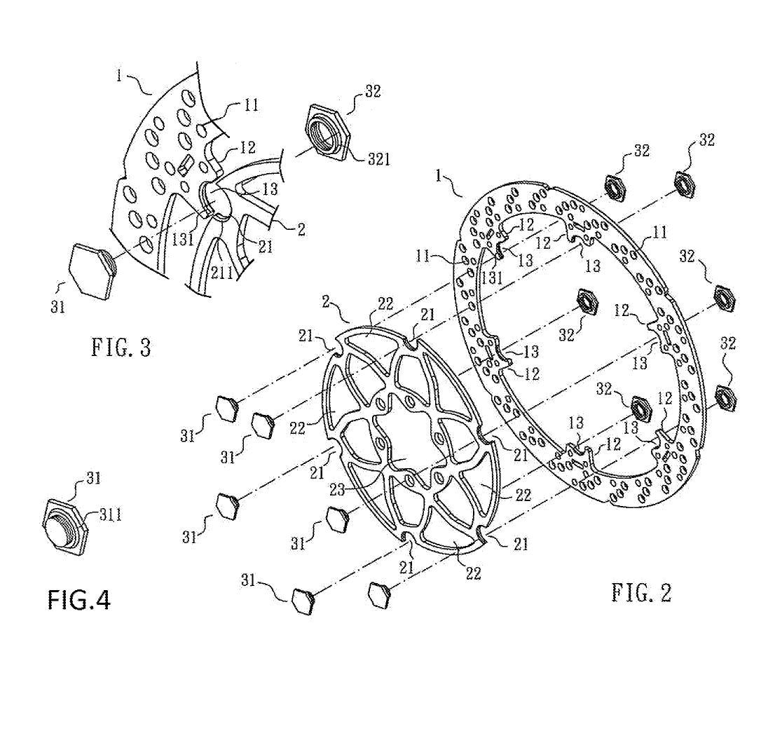

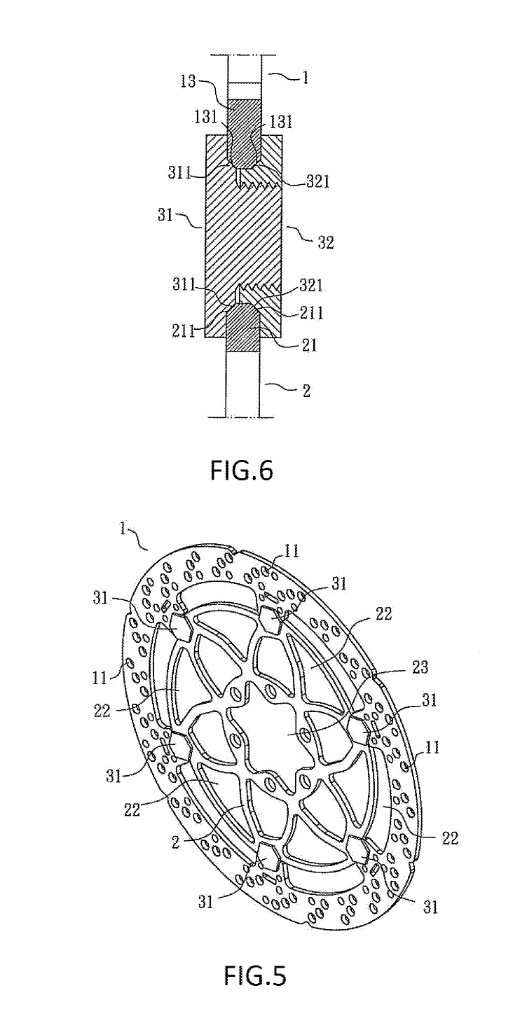

Referring to FIGS. 2 to 6, a brake disc assembly 1 in accordance with a first preferred embodiment of the invention comprises the following components as discussed in detail below.

A ring 1 includes a plurality of holes 11, a plurality of projections 12 equally spaced along an inner edge, and a plurality of half-circular cavities 13 each formed on the projection 12, the half-circular cavity 13 having two opposite inclined ends 131. A central part 2 includes a plurality of half-circular depressions 21 equally spaced along a periphery, a central hole 23, and a plurality of spaced hole members 22 surrounding the central hole 23. The half-circular depression 21 has two opposite inclined ends 211.

A plurality of fastening members each includes a bolt 31 having a threaded shank 311 and an internally threaded nut 32 having an inclined ramp 321. In assembly, the depressions 21 are attached to the cavities 13 to form a circular hole in which the inclined ends 131 of the cavity 13 are in close contact with the inclined ends 211 of the depression 21. Further, the threaded shank 311 is inserted through the circular hole into the nut 32 to fasten the projections 12 and the depressions 21 together. Thus, the ring 1 and the central part 2 are secured.

The ring 1 is made of cast iron and is adapted to transfer heat when heat is generated by two brake pads in the event of braking.

The central part 2 is made of a material having low thermal conductivity. Thus, the heat transfer from the ring 1 to the central part 2 is greatly reduced. Thus, a minimum heat is transferred to balls of a bearing (not shown). The bearing is thus thermally insulated. This can prolong the useful life of the bearing.

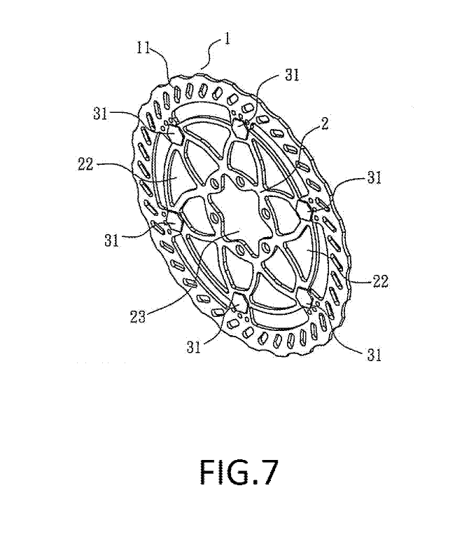

Referring to FIG. 7, the circular holes 11 are replaced by elongated holes 11.

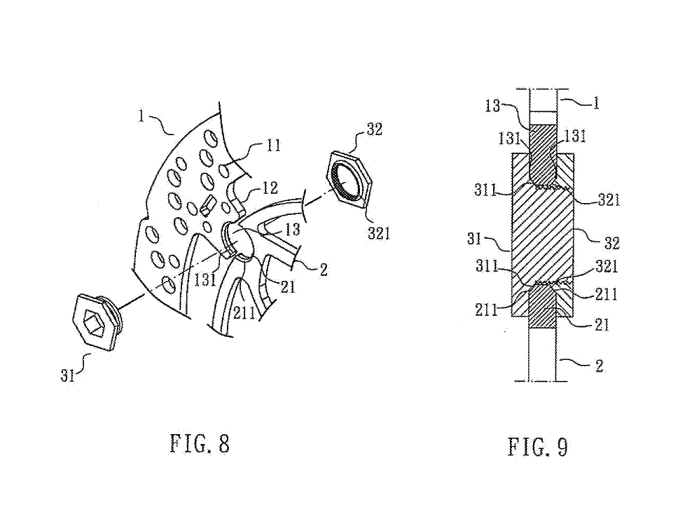

Referring to FIGS. 8 and 9, a second configuration of the fastening member is shown. The fastening member includes a bolt 31 having a hexagonal head (not numbered) and a threaded shank 311, and a hexagonal nut 32 having internal threads 321.

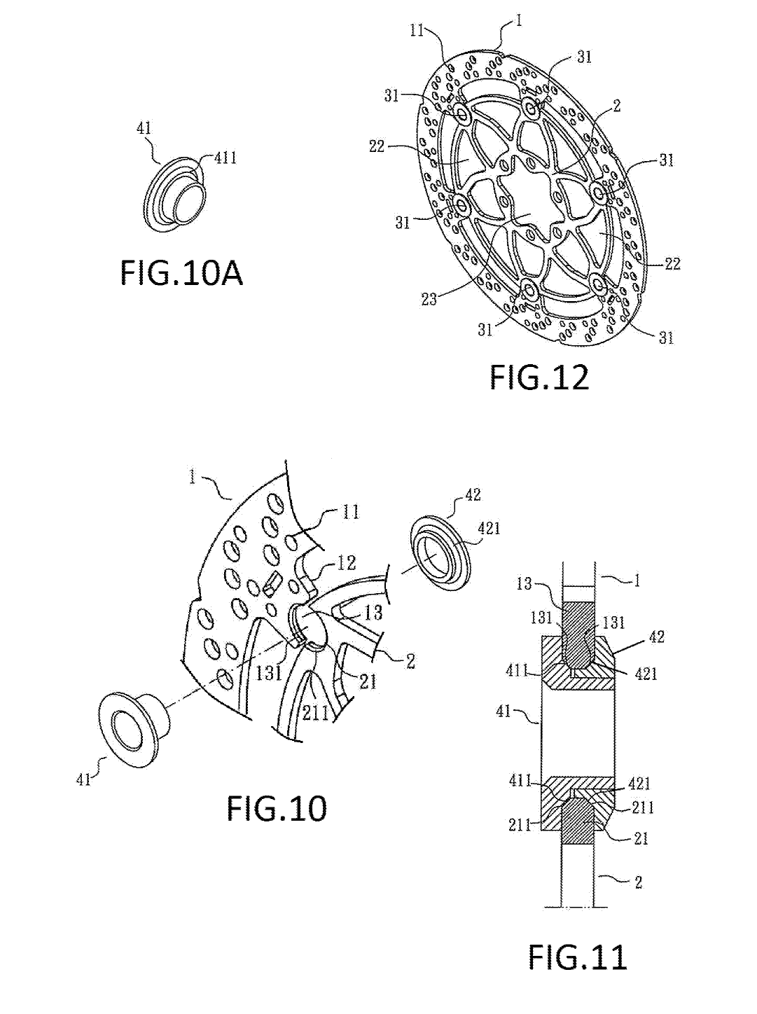

Referring to FIGS. 10, 10A, 11, and 12, a three configuration of the fastening member is shown. The fastening member includes a first fastening element 41 having an inclined shoulder 411, and a second fastening element 42 having an inclined shoulder 421. The first and second fastening elements 41, 42 are joined to fasten the ring 1 and the central part 2 together. The inclined shoulder 411 urges against one inclined end 131. The inclined shoulder 421 urges against the other inclined end 131.

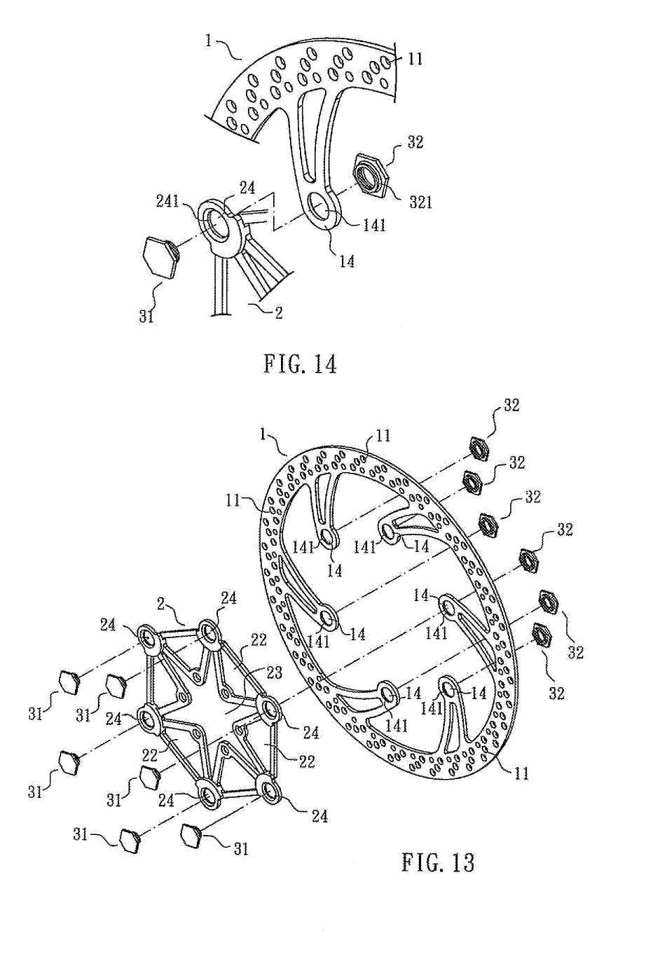

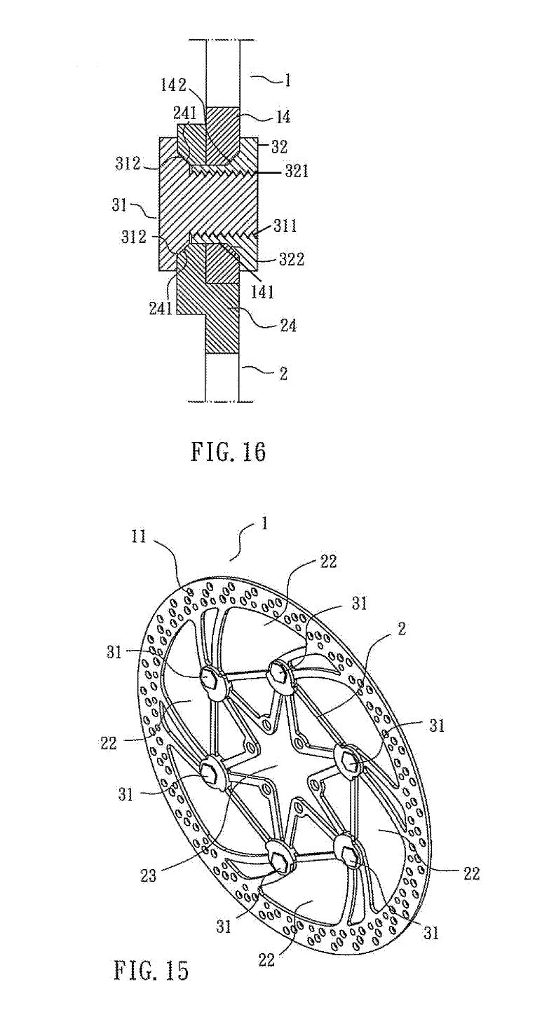

Referring to FIGS. 13 to 16, a brake disc assembly in accordance with a second preferred embodiment of the invention is shown. The characteristics of the second preferred embodiment are discussed below.

A ring 1 includes a plurality of holes 11 and a plurality of protrusions 14 equally spaced along an inner edge, each protrusion 14 having an aperture 141 distal the holes 11 and a ramp member 142 on one end of the aperture 141.

A central part 2 includes a plurality of through holes 24 equally spaced along a periphery, a central hole 23, and a plurality of spaced hole members 22 surrounding the central hole 23. The through hole 24 has a ramp 241.

A plurality of fastening members each includes a bolt 31 having a threaded shank 312 and a ramp member 312 formed between the head and the threaded shank 311; and a nut 32 having internal threads 321 and a ramp element 322 formed between the head and the internal threads 321.

In assembly, the through holes 24 are put on the protrusions 14 to be in register. Further, the threaded shank 311 is inserted through the through hole 24 and the aperture 141 into the internal threads 321 to fasten the through hole 24 and the protrusion 14 together. Thus, the ring 1 and the central part 2 are secured.

As shown in FIG. 16 specifically, the ramp member 312 is urged against the ramp 241 and the ramp member 142 is urged against the ramp element 322.

While the invention has been described in terms of preferred embodiments, those skilled in the art will recognize that the invention can be practiced with modifications within the spirit and scope of the appended claims.

What is claimed is:

1. A brake disc assembly comprising:
a ring including a plurality of holes and a plurality of protrusions equally spaced along an inner edge, each protrusion having an aperture distal the holes;
a central part includes a plurality of through holes equally spaced along a periphery, a central hole, and a plurality of spaced hole members surrounding the central hole;
a plurality of externally threaded bolts; and
a plurality of internally threaded nuts;
wherein the through holes and the protrusions are in register; and
wherein the externally threaded bolts are driven through the apertures and the through holes into the internally threaded nuts to fasten the ring and the central part together.

2. A brake disc assembly comprising:
a ring including a plurality of holes, a plurality of projections equally spaced along an inner edge, and a plurality of cavities each formed on one of the projections;
a central part includes a plurality of depressions equally spaced along a periphery, a central hole, and a plurality of spaced hole members surrounding the central hole;
a plurality of externally threaded bolts; and
a plurality of internally threaded nuts;
wherein the cavities and the depressions are in contact each other; and
wherein the externally threaded bolts are driven through the cavities and the depressions into the internally threaded nuts to fasten the ring and the central part together.
